(19) United States
(12) Patent Application Publication
(10) Pub. No.: US 2023/0126097 A1
(43) Pub. Date: Apr. 27, 2023

(54) Infrared Transmissive Member and Fourier Transform Infrared Spectroscope

(71) Applicant: SHIMADZU CORPORATION, Kyoto (JP)

(72) Inventor: Shinya WAKUDA, Kyoto-shi (JP)

(73) Assignee: SHIMADZU CORPORATION, Kyoto (JP)

(21) Appl. No.: 17/969,650

(22) Filed: Oct. 19, 2022

(30) Foreign Application Priority Data
Oct. 21, 2021 (JP) 2021-172303

(51) Int. Cl. G02B 1/02; G02B 1/10

(52) U.S. Cl. CPC G02B 1/02; G02B 1/10; G01J 3/453

(57) ABSTRACT

An infrared window includes a substrate composed of “KRS-5” as a raw material which is mixed crystal of thallium iodide and thallium bromide and an infrared transmissive coating that covers a surface of the substrate. A raw material for the infrared transmissive coating is parylene. A thickness of the infrared transmissive coating is set to a value at which an infrared absorptance is lower than 3%. The thickness of the infrared transmissive coating is set to a value at which the infrared absorptance is lower than 3%. The thickness of the infrared transmissive coating is set to a value within a range not smaller than 20 nanometers and smaller than 50 nanometers.

### CROSS-REFERENCE TO RELATED APPLICATION

This application claims the priority benefits of Japanese application no. 2021-172303, filed on Oct. 21, 2021. The entirety of the above-mentioned patent application is hereby incorporated by reference herein and made a part of this specification.

### BACKGROUND OF THE INVENTION

### Field of the Invention

The present disclosure relates to an infrared transmissive member and a Fourier transform infrared spectroscope including the infrared transmissive member.

### Description of the Background Art

A Fourier transform infrared spectroscope (FTIR) generates interfering light by splitting infrared light from a light source into two beams with the use of a beam splitter in the inside of a housing. This interfering light is emitted from the inside of the housing to the outside of the housing through an infrared window. The interfering light emitted to the outside of the housing irradiates a sample, light that has passed through or is reflected by the sample is detected by a detector, and a detection signal from the detector is sent to a data processing apparatus. The data processing apparatus creates a spectrum by Fourier transform of the detection signal from the detector, and conducts qualitative or quantitative analysis of the sample based on a peak wavelength and a peak intensity of the spectrum (see, for example, WO2016/166872).

In addition to an optical material such as potassium bromide (KBr), sodium chloride (NaCl), or zinc selenide (ZnSe), a material called “KRS-5” which is mixed crystal of thallium iodide and thallium bromide has conventionally often been used as a raw material for an infrared transmissive member such as an infrared window of an FTIR. KRS-5 is characterized in that it allows passage therethrough of infrared rays over a wide range from near-infrared rays to far-infrared rays and it is higher also in moisture resistance than salt such as KBr or NaCl. Therefore, KRS-5 can be concluded as an optical material superior to other raw materials in achieving both of moisture resistance and passage therethrough of infrared rays over a wide range.

It has been found, however, that KRS-5 is likely to deteriorate due to oxidation depending on an environment of use. Specifically, thallium which is a component of KRS-5 is very prone to oxidation and thallium oxide may be formed on a surface of KRS-5 depending on an environment of use. Formation of thallium oxide on the surface of KRS-5 leads to lowering in transmittance of infrared light, and there is a concern about failure in irradiation of a sample with a sufficient amount of infrared light.

The present disclosure was made to improve oxidation resistance of an infrared transmissive member composed of KRS-5 as a raw material.

### SUMMARY OF THE INVENTION

The infrared transmissive member according to the present disclosure includes a substrate composed of KRS-5 as a raw material and an infrared transmissive coating that covers a surface of the substrate.

A Fourier transform infrared spectroscope according to the present disclosure includes the infrared transmissive member described above.

### BRIEF DESCRIPTION OF THE DRAWINGS

FIG. 1 is a diagram schematically showing an exemplary configuration of an FTIR.

FIG. 2 is a diagram showing an infrared transmittance of a material used as a raw material for an infrared window.

FIG. 3 is a diagram schematically showing a cross-section of the infrared window.

FIG. 4 shows a measurement value of an infrared transmittance of KRS-5 coated with parylene.

FIG. 5 shows a measurement value of an infrared transmittance of KRS-5 coated with DLC.

FIG. 6 shows a measurement value of an infrared transmittance of KRS-5 coated with fluorine.

### DESCRIPTION OF THE PREFERRED EMBODIMENTS

The present disclosure will become more apparent from the following detailed description of the present invention when taken in conjunction with the accompanying drawings.

An embodiment of the present disclosure will be described in detail below with reference to the drawings. The same or corresponding elements in the drawings have the same reference characters allotted and description thereof will not be repeated.

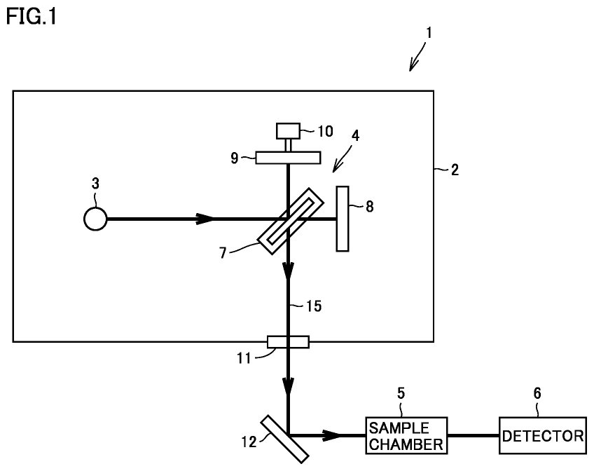

FIG. 1 is a diagram schematically showing an exemplary configuration of a Fourier transform infrared spectroscope (FTIR) 1 including an infrared window 11 (infrared transmissive member) according to the present embodiment.

FTIR 1 includes a housing 2, a heater 3, an interference portion 4, a sample chamber 5, and a detector 6. Housing 2 is formed in a shape of a hollow box. Heater 3 is arranged in housing 2. Heater 3 may be, for example, a ceramic heater. Heater 3 emits infrared measurement light as measurement light, for example, by being fed with a current.

Interference portion 4 is arranged in housing 2. Interference portion 4 is a mechanism for generating infrared interfering light and arranged downstream from heater 3 in an optical path. Interference portion 4 includes a beam splitter 7, a fixed mirror 8, a moving mirror 9, and a driver 10.

Beam splitter 7 is arranged at a distance from heater 3. Beam splitter 7 is constructed to reflect some of incident light and to allow passage of remaining incident light.

Fixed mirror 8 is arranged opposite to heater 3 with beam splitter 7 being interposed. Fixed mirror 8 is arranged as being fixed at a certain position. Moving mirror 9 is arranged at a distance from beam splitter 7 and fixed mirror 8. Moving mirror 9 is constructed as being movable in a direction in which beam splitter 7 and moving mirror 9 are connected to each other. Driver 10 is constructed to provide driving force to moving mirror 9.

A portion of housing 2 opposed to interference portion 4 is provided with an infrared window 11 for passage of infrared light. Sample chamber 5 is arranged at a distance from housing 2. Sample chamber 5 is formed in a shape of a hollow box. A sample is accommodated in sample chamber 5. In the optical path, a reflector 12 is arranged upstream from sample chamber 5. Detector 6 is arranged at a distance from sample chamber 5.

In analysis of a sample by FTIR 1, infrared light is emitted from heater 3. Infrared light then enters beam splitter 7. Some of infrared light incident on beam splitter 7 passes through beam splitter 7 and is incident on fixed mirror 8, and remaining infrared light is reflected by beam splitter 7 and incident on moving mirror 9. Moving mirror 9 is moved by receiving driving force from driver 10.

Infrared light reflected by fixed mirror 8 is reflected by beam splitter 7 and is directed toward reflector 12. Infrared light reflected by moving mirror 9 passes through beam splitter 7 and is directed toward reflector 12. Infrared light reflected by fixed mirror 8 and infrared light reflected by moving mirror 9 are thus synthesized to become infrared interfering light 15.

Infrared interfering light 15 passes through infrared window 11 from the inside of housing 2 and is emitted to the outside of housing 2. Infrared interfering light 15 emitted to the outside of housing 2 is reflected by reflector 12 and enters sample chamber 5. The sample in sample chamber 5 is thus irradiated with infrared interfering light 15. Light reflected from the sample or light that has passed through the sample is emitted from sample chamber 5 and enters detector 6.

Detector 6 outputs an interferogram in accordance with incident infrared light as a detection signal. As the detection signal from detector 6 is subjected to Fourier transform in FTIR 1, the FTIR creates spectrum intensity distribution data. The sample is analyzed based on the data.

<Raw Material for Infrared Window 11>

In addition to an optical material such as KBr, NaCl, or ZnSe, a material called “KRS-5” has conventionally often been used as a raw material for the infrared window. KRS-5 is mixed crystal of thallium iodide and thallium bromide.

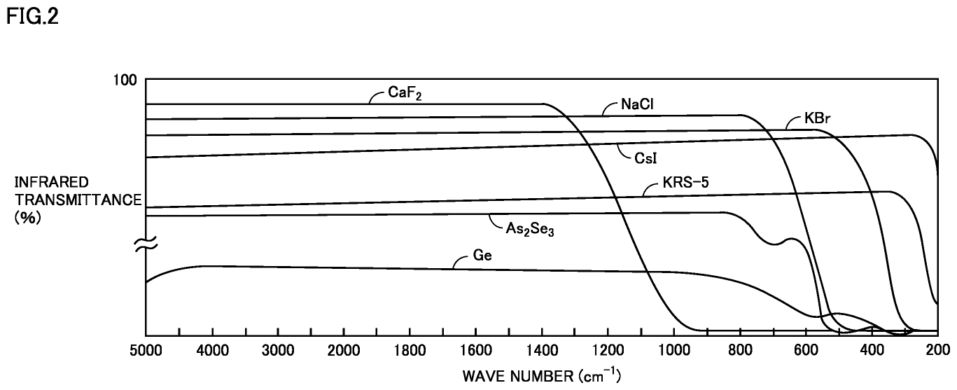

FIG. 2 is a diagram showing an infrared transmittance of a material used as a raw material for the infrared window. In FIG. 2, the abscissa represents a wave number (a reciprocal of a wavelength, unit of cm⁻¹) and the ordinate represents an infrared transmittance. A range of wave numbers of infrared rays is approximately from 4000 to 400 cm⁻¹. FIG. 2 shows infrared transmittances of KBr, NaCl, calcium fluoride (CaF₂), cesium iodide (CsI), arsenic triselenide (As₂Se₃), and germanium (Ge) in addition to KRS-5.

As shown in FIG. 2, it can be understood that KRS-5, KBr, and CsI are more likely to allow passage therethrough of infrared rays over a wide range from near-infrared rays to far-infrared rays than other materials.

Among KRS-5, KBr, and CsI that allow passage therethrough of infrared rays over a wide range, KBr and CsI are low in moisture resistance. When KBr and CsI come in contact with water vapor in air, they deliquesce and become whitish, which results in lowering in infrared transmittance. In contrast, KRS-5 is higher in moisture resistance than KBr and CsI. Therefore, KRS-5 can be concluded as an optical material superior to other materials in achieving both of moisture resistance and passage therethrough of infrared rays over a wide range.

In view of the above, in the present embodiment, “KRS-5” is adopted as a raw material for infrared window 11.

<Coating of Infrared Window 11 (KRS-5)>

For the purpose to improve moisture resistance of KBr low in moisture resistance, in some cases, a moisture-resistant coating has conventionally been provided onto a surface of KBr. On the other hand, KRS-5 is high in moisture resistance, and hence a coating that has conventionally been provided to KBr has not been provided to KRS-5.

It has been found, however, that KRS-5 is likely to deteriorate due to oxidation depending on an environment of use. Specifically, thallium which is a component of KRS-5 is very prone to oxidation and thallium oxide may be formed on a surface of KRS-5 depending on an environment of use. Formation of thallium oxide on the surface of KRS-5 leads to lowering in infrared transmittance. Lowering in infrared transmittance of infrared window 11 leads to a concern about failure in irradiation of a sample in sample chamber 5 with a sufficient amount of infrared interfering light 15.

Then, in infrared window 11 according to the present embodiment, a surface of KRS-5 is coated with an infrared transmissive coating for oxidation resistance.

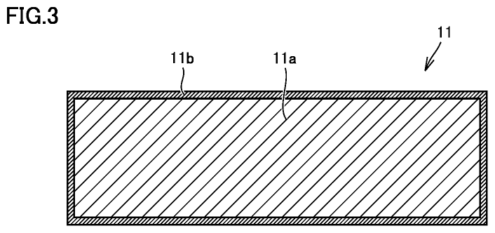

FIG. 3 is a diagram schematically showing a cross-section of infrared window 11 according to the present embodiment. As shown in FIG. 3, infrared window 11 includes a substrate 11a composed of KRS-5 as a raw material and an infrared transmissive coating 11b that covers a surface of substrate 11a.

In particular, in the present embodiment, “parylene” effective for preventing oxidation of KRS-5 is adopted as a raw material for infrared transmissive coating 11b. Parylene is an organic substance having such a structure that a methylene group is located at each of opposing ends of a benzene ring, and it becomes a very stable clear and colorless polymer by being polymerized. Parylene is excellent in moistureproofness, rustproofness, water resistance, and gas barrier property. In particular, oxygen barrier property of parylene is significantly higher than that of fluorine, and it may be approximately at least one hundred times higher.

A thickness of infrared transmissive coating 11b is determined from a point of view of ensuring oxygen barrier property and transparency (appearance) of infrared transmissive coating 11b. From a point of view of ensuring oxygen barrier property, a thickness of infrared transmissive coating 11b is desirably set to a value approximately not smaller than 10 nanometers (nm). Since parylene is poorer in transparency as a thickness thereof is larger, from a point of view of ensuring transparency, the thickness of infrared transmissive coating 11b is desirably set to a value smaller than 100 nm.

Therefore, in the present embodiment, the thickness of infrared transmissive coating 11b is set to a value of the order of several ten nanometers, specifically, a value within a range not smaller than 10 nanometers and smaller than 100 nanometers. Thus, while oxygen barrier property of infrared transmissive coating 11b is ensured, transparency of infrared transmissive coating 11b can be ensured.

Furthermore, since parylene is an organic substance and absorbs infrared light, infrared transmission property may be impaired when parylene has a large thickness. From a point of view of ensuring infrared transmission property, the thickness of infrared transmissive coating 11b is desirably set to a value at which an infrared absorptance of infrared transmissive coating 11b is lower than 3%, specifically, a value approximately smaller than 50 nm.

Based on the points of view above, in the present embodiment, the thickness of infrared transmissive coating 11b is set to a value within a range from 20 to 50 nm such that the infrared absorptance of infrared transmissive coating 11b can be lower than 3% while oxygen barrier property and transparency of infrared transmissive coating 11b are ensured.

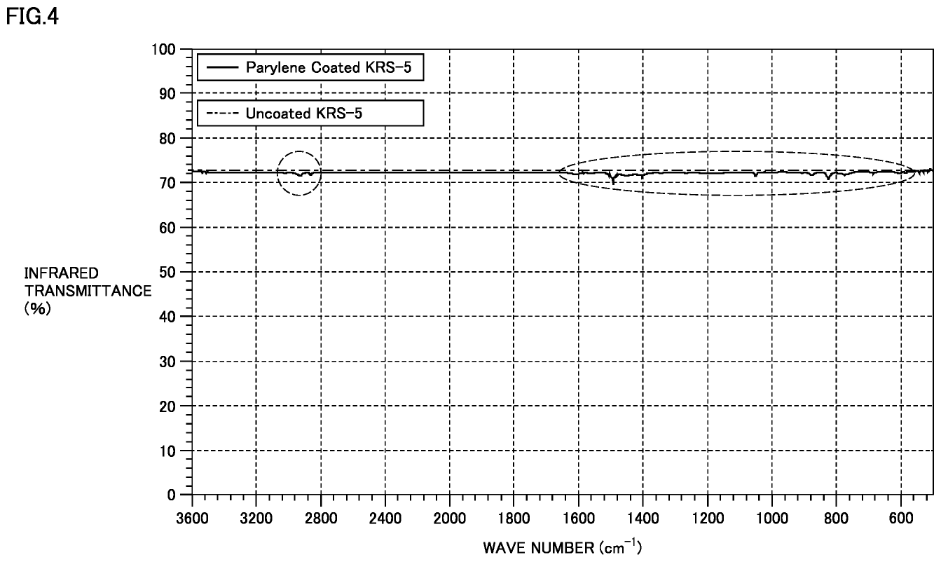

FIG. 4 shows a measurement value of an infrared transmittance of KRS-5 coated with parylene. FIG. 4 shows the infrared transmittance of KRS-5 coated with parylene with a solid line and shows the infrared transmittance of uncoated KRS-5 with a chain dotted line. Parylene used for measurement has a thickness around 40 nm.

As described above, parylene is an organic substance and absorbs infrared light. A thickness around 20 nm, however, does not much affect absorption of infrared rays. Therefore, while a sufficient amount of infrared light passes through infrared window 11 in the present embodiment, oxidation of KRS-5 can be suppressed and durability of infrared window 11 can be improved.

KRS-5 coated with parylene is observed to experience lowering in infrared transmittance due to absorption of infrared rays by parylene in a range of wave numbers surrounded by a dashed line in FIG. 4, specifically, in a range of wave numbers approximately from 3050 to 2900 cm⁻¹ and a range of wave numbers from 1650 to 600 cm⁻¹. In each of the ranges, however, lowering in infrared transmittance is approximately 2% at the maximum and suppressed within an allowable range (lower than 3%).

As set forth above, infrared window 11 according to the present embodiment includes substrate 11a composed of KRS-5 as a raw material and infrared transmissive coating 11b that is composed of parylene as a raw material and covers a surface of substrate 11a. Oxidation resistance of infrared window 11 composed of KRS-5 as the raw material can thus be improved. Consequently, even when infrared window 11 is used in an environment where oxidation progresses, the infrared transmittance of infrared window 11 can be maintained for a long period.

[First Modification]

Though parylene is employed as a raw material for infrared transmissive coating 11b in the embodiment described above, diamond-like carbon (DLC) may also be adopted as a raw material for infrared transmissive coating 11b. DLC is a generic name of a thin coating made of a substance composed mainly of carbon and having both of a structure of diamond and a structure of graphite.

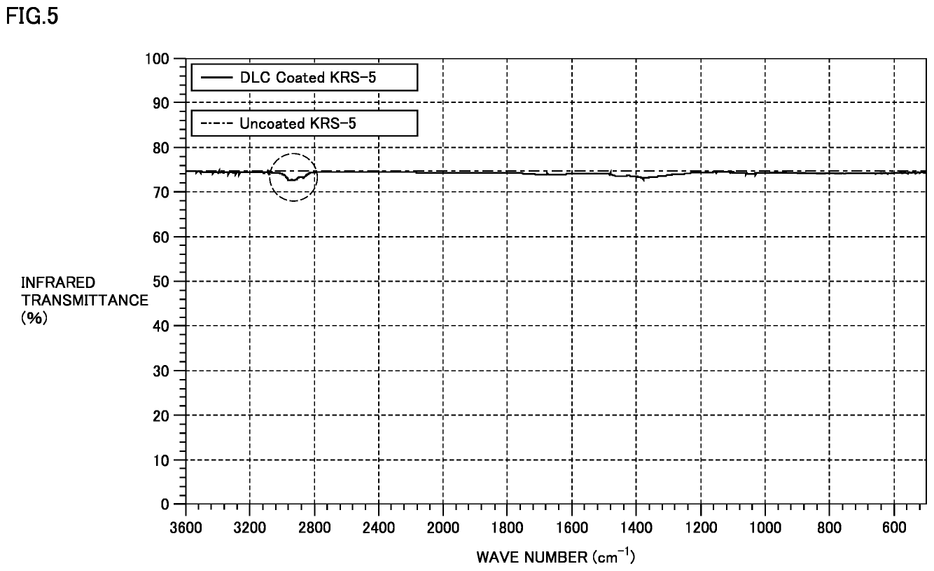

FIG. 5 shows a measurement value of an infrared transmittance of KRS-5 coated with DLC. FIG. 5 shows the infrared transmittance of KRS-5 coated with DLC with a solid line and shows the infrared transmittance of uncoated KRS-5 with a chain dotted line. DLC used for measurement has a thickness around 40 nm.

KRS-5 coated with DLC is observed to experience lowering in infrared transmittance due to absorption of infrared rays by DLC in a range of wave numbers surrounded by a dashed line in FIG. 5, specifically, in a range of wave numbers approximately from 3000 to 2800 cm⁻¹. Similarly to the case of parylene, however, lowering in infrared transmittance is approximately 2% at the maximum and suppressed within an allowable range (lower than 3%).

Therefore, even when DLC is adopted as the raw material for infrared transmissive coating 11b, similarly to parylene, while passage of a sufficient amount of infrared light is allowed, oxidation of KRS-5 can be suppressed and durability of infrared window 11 can be improved.

DLC may be more expensive than parylene. Therefore, adoption of parylene as the raw material for infrared transmissive coating 11b can be lower in cost of infrared window 11 than adoption of DLC as the raw material for infrared transmissive coating 11b.

[Second Modification]

Though parylene or DLC is adopted as the raw material for infrared transmissive coating 11b in the embodiment and the first modification described above, fluorine can also be adopted as the raw material for infrared transmissive coating 11b.

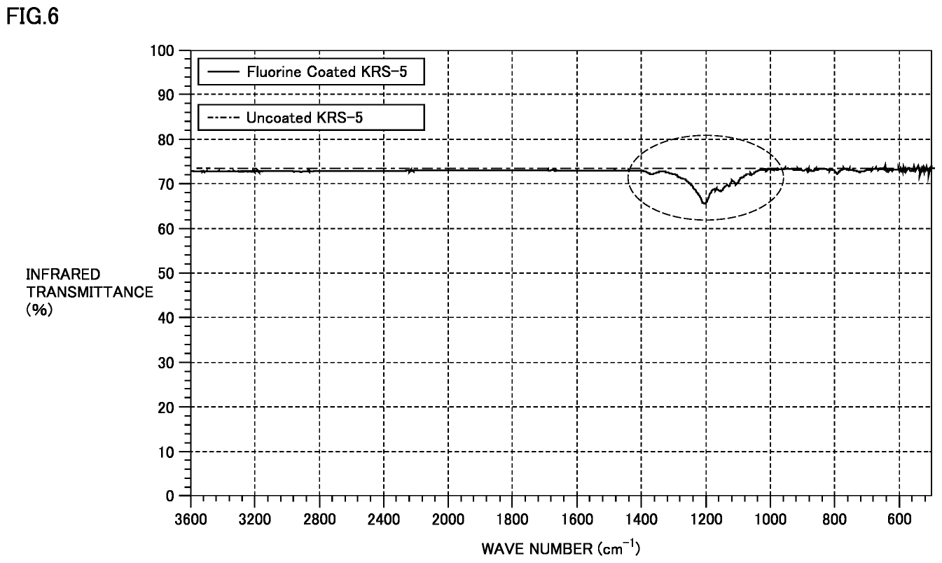

FIG. 6 shows a measurement value of an infrared transmittance of KRS-5 coated with fluorine. FIG. 6 shows the infrared transmittance of KRS-5 coated with fluorine with a solid line and shows the infrared transmittance of uncoated KRS-5 with a chain dotted line. Fluorine used for measurement has a thickness around 20 nm.

KRS-5 coated with fluorine is observed to experience significant lowering in infrared transmittance by an amount close to 10% due to absorption of infrared rays by fluorine in a range of wave numbers surrounded by a dashed line in FIG. 6, specifically, in a range of wave numbers approximately from 1400 to 1000 cm⁻¹. Therefore, coating with fluorine is poorer in infrared transmission property than coating with parylene or DLC.

In a range of wave numbers other than the range from 1400 to 1000 cm⁻¹, however, substantially no lowering in infrared transmittance is observed. Therefore, lowering in infrared transmittance in the range of wave numbers from 1400 to 1000 cm⁻¹ is allowable, oxidation of KRS-5 can be suppressed by coating of KRS-5 with fluorine as compared to absence of the coating.

As described above, however, parylene is much higher in oxygen barrier property than fluorine. Therefore, adoption of parylene as the raw material for infrared transmissive coating 11b can more appropriately improve oxidation resistance of KRS-5 than adoption of fluorine as the raw material for infrared transmissive coating 11b.

[Aspects]

The embodiment and the modifications thereof described above are understood by a person skilled in the art as specific examples of aspects below.

(Clause 1)

An infrared transmissive member according to one aspect includes a substrate composed of KRS-5 as a raw material and an infrared transmissive coating that covers a surface of the substrate.

According to the infrared transmissive member described in Clause 1, the surface of the substrate composed of KRS-5 as the raw material is covered with the infrared transmissive coating. Oxidation resistance of the infrared transmissive member composed of KRS-5 as the raw material can thus be improved. Consequently, even when the infrared transmissive member is used in an environment where oxidation progresses, the infrared transmittance of the infrared transmissive member can be maintained for a long period.

(Clause 2)

In the infrared transmissive member according to Clause 1, a raw material for the infrared transmissive coating is parylene.

According to the infrared transmissive member described in Clause 2, by adopting parylene excellent in oxygen barrier property as the raw material for the infrared transmissive coating, oxidation resistance of the infrared transmissive member can appropriately be improved.

(Clause 3)

In the infrared transmissive member according to Clause 1 or 2, a thickness of the infrared transmissive coating is set to a value at which an infrared absorptance is lower than 3%.

According to the infrared transmissive member described in Clause 3, the thickness of the infrared transmissive coating is set to a value at which the infrared absorptance of the infrared transmissive coating is lower than 3%. Therefore, while lowering in infrared transmittance due to absorption of infrared rays by the infrared transmissive coating is suppressed to less than 3%, oxidation resistance of the infrared transmissive member can be improved.

(Clause 4)

In the infrared transmissive member according to any one of Clauses 1 to 3, a thickness of the infrared transmissive coating is set to a value within a range not smaller than 10 nanometers and smaller than 100 nanometers.

According to the infrared transmissive member described in Clause 4, oxygen barrier property and transparency of the infrared transmissive coating can be ensured.

(Clause 5)

In the infrared transmissive member according to any one of Clauses 1 to 3, a thickness of the infrared transmissive coating is set to a value within a range not smaller than 20 nanometers and smaller than 50 nanometers.

According to the infrared transmissive member described in Clause 5, while oxygen barrier property and transparency of the infrared transmissive coating are ensured, the infrared absorptance can be suppressed within an allowable range (for example, lower than 3%).

(Clause 6)

In the infrared transmissive member according to Clause 1, a raw material for the infrared transmissive coating is diamond-like carbon.

According to the infrared transmissive member described in Clause 6, by adopting diamond-like carbon excellent in oxygen barrier property as the raw material for the infrared transmissive coating, oxidation resistance of the infrared transmissive member can appropriately be improved.

(Clause 7)

A Fourier transform infrared spectroscope according to one aspect includes the infrared transmissive member described in any one of Clauses 1 to 6.

According to this Fourier transform infrared spectroscope, the Fourier transform infrared spectroscope including the infrared transmissive member can be implemented.

Though an embodiment of the present invention has been described, it should be understood that the embodiment disclosed herein is illustrative and non-restrictive in every respect. The scope of the present invention is defined by the terms of the claims and is intended to include any modifications within the scope and meaning equivalent to the terms of the claims.

What is claimed is:

1. An infrared transmissive member comprising:
a substrate composed of KRS-5 as a raw material; and
an infrared transmissive coating that covers a surface of the substrate.

2. The infrared transmissive member according to claim 1, wherein
a raw material for the infrared transmissive coating is parylene.

3. The infrared transmissive member according to claim 1, wherein
a thickness of the infrared transmissive coating is set to a value at which an infrared absorptance is lower than 3%.

4. The infrared transmissive member according to claim 1, wherein
a thickness of the infrared transmissive coating is set to a value within a range not smaller than 10 nanometers and smaller than 100 nanometers.

5. The infrared transmissive member according to claim 1, wherein
a thickness of the infrared transmissive coating is set to a value within a range not smaller than 20 nanometers and smaller than 50 nanometers.

6. The infrared transmissive member according to claim 1, wherein
a raw material for the infrared transmissive coating is diamond-like carbon.

7. A Fourier transform infrared spectroscope comprising the infrared transmissive member according to claim 1.
